(19) United States
(12) Patent Application Publication
(10) Pub. No.: US 2005/0186046 A1
(43) Pub. Date: Aug. 25, 2005

(54) Self-piercing nut for use with thick panels

(76) Inventor: Katsumi Shinjo, Osaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/050,846

(22) Filed: Feb. 7, 2005

(30) Foreign Application Priority Data
Feb. 24, 2004 (JP) JP2004-047564

(51) Int. Cl. F16B 37/04

(52) U.S. Cl. 411/180

(57) ABSTRACT

A self-piercing nut for use with relatively thick metal panels has four independent posts (9) formed integral with respective corners of a nut body (2) and providing four seat faces (10). The pilot portion (6) has an end face (7) for punching a hole in the panel is projected beyond the seat faces, and the nut body (2) is a pressed boron steel article entirely hardened by the quenching method so as to show a strong piercing force. Height ‘H’ defined between a bottom of the panel engaging groove (8) and the pilot portion end face (7) is generally equal to maximum thickness of the metal panel. Further height ‘h’ defined between the seat face (10) of each corner post (9) and the pilot portion end face is generally equal to minimum thickness of the panel.

### FIELD OF THE INVENTION

The present invention relates to a self-piercing nut that comprises a nut body for punching a hole in a metal panel as any of relatively thick panels in such a manner that a generally circular edge of the hole is caulked to bite and fix the nut in position, even if thickness of the thick panels varies within a considerably wide range.

### PRIOR ART

The prior art self-piercing nuts have been used mainly in manufacture of automobile cars so as to fasten relatively thin metal panels thick about 1.0 mm.

However, certain high-stress type self-piercing nuts have recently been demanded for use with relatively thick metal panels (thick about 1.6 mm to 3.2 mm) to be incorporated in buildings or the like architectures.

An example of the high-stress type self-piercing nuts is known in the art (see for example the Japanese Patent Publication No. 61-49528) that had been proposed by the present inventor.

The present invention was made to improve this nut to meet the recent requirement noted above.

### SUMMARY OF THE INVENTION

An object of the present invention is therefore to provide a novel self-piecing nut designed for use with relatively thick metal panels even if they are of varied thickness.

In order to achieve this object, a self-piercing nut proposed herein may comprise a generally square nut body with four side walls, a pilot portion formed on and integral with the nut body and around a central threaded bore thereof, and this portion having a projected end face to punch a hole in a metal panel and having an outer periphery tapered to inwardly reduce diameter across a nut axis. The present nut may further comprise a panel engaging groove formed around and outside the pilot portion and opened sideways at regions except for four corners of the nut boy, and four independent corner posts that are formed integral with the respective corners so as to provide four seat faces, such that the metal panel will be brought into a forced contact with the corner posts. The pilot portion has an end face projected beyond the seat faces in a direction of the nut axis. The nut body is a pressed article of boron steel and has entirely been hardened by the quenching method for strengthening the pilot portion as to its punching force. Also characteristically, a height ‘H’ defined between a bottom of the panel engaging groove and the pilot portion end face is substantially equal to an allowable maximum thickness of the metal panel, and another height ‘h’ defined between the seat face of each corner post and the pilot portion end face is substantially equal to an allowable minimum thickness of the metal panel.

In use, the pilot portion will punch a round hole in the metal panel so that a circular edge of this hole is forcibly caulked into the panel engaging groove. The seat faces of corner posts will bite the panel at its areas near the circular edge if the thickness of the panel is greater than a threshold, and in this occasion the corner posts will buckle vertically and swell sideways more or less to a noticeable degree. As a result of such a deformation, the self-piercing nut will obtain a sufficient resistance to puling-off and idle rotations.

It will now be apparent that the present self-piercing nut is particularly adapted for use with relatively thick metal panels, nevertheless allowing this nut to be used in common for fixation thereof to any metal panels of considerably different thickness. In any case, this nut thus strongly attached to the panels will withstand well any external forces tending to pull off or idly rotate this nut.

### BRIEF DESCRIPTION OF THE DRAWINGS

FIG. 1 is a perspective view of a self-piercing nut provided by the present invention;

FIG. 2 is a plan view of the nut shown in FIG. 1;

FIG. 3 is a cross section taken along the line 3-3 in FIG. 2;

FIG. 4 is a cross section taken along the line 4-4 in FIG. 2;

FIG. 5 is a cross section of the nut attached to a metal panel of an allowable maximum thickness; and

FIG. 6 also is a cross section of the nut attached to another metal panel of an allowable minimum thickness.

### THE PREFERRED EMBODIMENTS

Now some embodiments of the present invention will be described referring to the accompanying drawings.

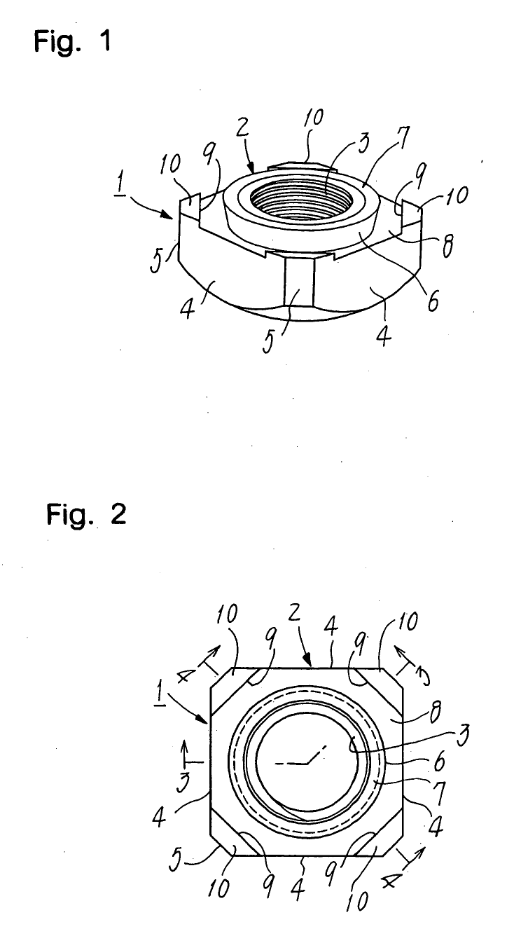

FIGS. 1 to 4 show a self-piercing nut 1 provided herein and comprising a nut body 2 that is generally square. This nut body having four side walls 4 is chamfered at its four corners 5, and a central threaded bore 3 penetrates the nut body. A pilot portion 6 surrounding the central bore has an outer periphery tapered to inwardly reduce diameter across the nut axis and an end face 7 for punching a hole in a metal panel. A panel engaging groove 8 surrounding such a pilot portion 6 is opened sideways at the side walls 4, but closed sideways at the corners. Four discrete corner posts 4 integrally protrude from the respective corners of the nut body 2 so as to provide seat faces 10 for a forced contact with the metal panel. The end face 7 of pilot portion 6 is projected ahead the seat faces 10 of corner posts 9.

The nut body 2 is made from a strong boron steel rod so as to reinforce the pilot portion 6 to such a degree that a hole can be punched in any thicker metal panels. In manufacture, a piece of such a boron steel rod will be pressed into the shape at first, before quenched and hardened. Preferably in this invention, the boron steel may contain about 0.17% or less by weight of carbon so that it will obtain a Rockwell hardness HRC-30 or higher by the hardening process.

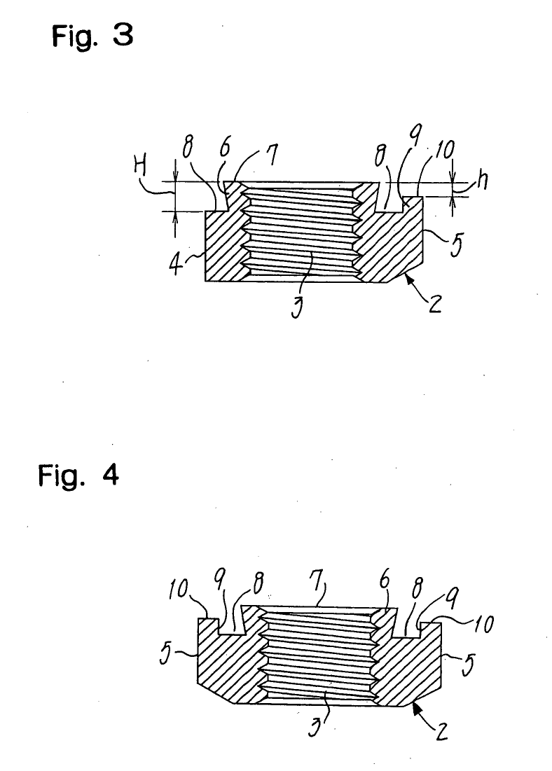

In order to make versatile the self-piercing nut 1 of the invention to be useful with many metal panels of different thickness, a configuration as will be seen from FIG. 3 is proposed herein. In detail, height ‘H’ defined between a bottom of the panel engaging groove 8 of nut body 2 and the end face 7 of pilot portion 6 is made substantially equal to an allowable maximum thickness of the metal panel. Another height ‘h’ defined between the seat face 10 of each corner post 9 and the pilot portion end face 7 is made substantially equal to an allowable minimum thickness of the metal panel.

For example, the maximum and minimum thickness ‘H’ and ‘h’ may be about 3.2 mm and about 1.6 mm, respectively.

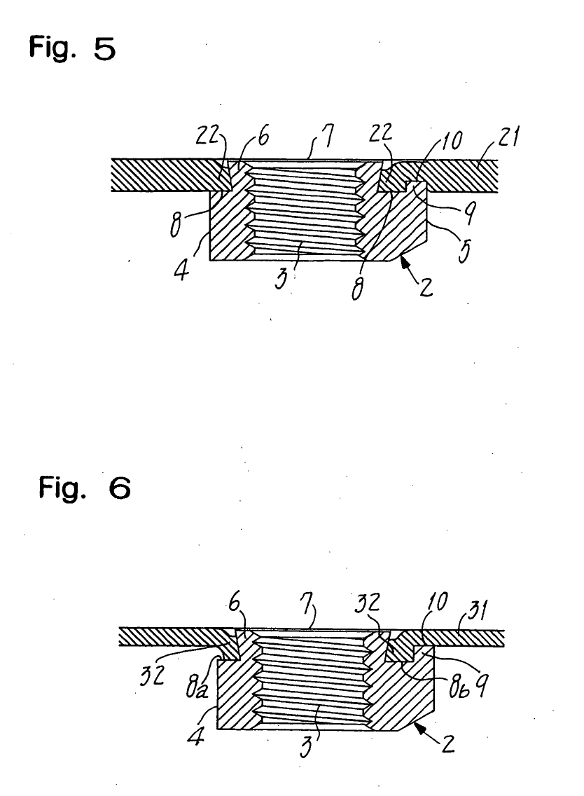

FIG. 5 illustrates one of the manners of using the self-piercing nut 1 of the described structure, wherein it is attached to a metal panel 21 of the maximum thickness (about 3.2 mm). In this state, the end face 7 of pilot portion 6 is in flush with the front side of this panel 21, and a circular edge 22 of a round hole punched in this panel by the pilot portion 6 is forced into the panel engaging groove 8 so as to be caulked therein. At the groove's 8 areas opened to the side walls 4, regions of such a circular edge 22 are forced into a close contact with both of the bottom of said groove 8 and the outer periphery of pilot portion 6. In contrast, at the groove's other areas adjacent to the corner posts 9, the seat faces 10 thereof will be forced to bite the metal panel 21 at its portions adjacent to the circular edge 22 that is simultaneously pressed into the groove and brought into a forced contact with the outer periphery of pilot portion 6. The self-piercing nut will obtain by this way a sufficient resistance to puling-off and idle rotations. When the seat faces 10 bite the panel 21 in this fashion, the corner posts 9 will buckle to reduce their height to a noticeable extent that depends on the material of metal panel 21. Such a deformation will cause the corner posts 9 to swell sideways to improve fixation strength of the nut body 2 attached to the metal panel 21.

If the outer periphery of pilot portion 6 has an uneven contour in cross section due to corrugation, indentations or the like, then the circular edge 22 will be bitten by such an uneven periphery to further strengthen this nut in its resistance to idle rotations.

FIG. 6 illustrates the other manner of using the self-piercing nut 1 of the described structure, wherein it is attached to another metal panel 31 of the minimum thickness (about 1.6 mm). Also in this state, the end face 7 of pilot portion 6 is in flush with the front side of this panel 31. A circular edge 32 of a round hole punched in this panel by the pilot portion 6 will be forced into the panel engaging groove 8 so as to be caulked therein. At the groove's areas 8a opened to the side walls 4, regions adjacent to such a circular edge 32 are bent inwards and forced into a close contact with the outer periphery of pilot portion 6, with the tip end or the edge itself resting on the bottom of said groove 8. At the groove's other areas 8b adjacent to the corner posts 9, the seat faces 10 thereof will support the metal panel 31 on a back side thereof. Also at these areas, the panel portions near the circular edge 32 are bent inwards and brought into a forced contact with the outer periphery of pilot portion 6. The self-piercing nut will obtain by this way a strong resistance to puling-off and idle rotations, thereby affording high fixation strength of the nut body 2 attached to the metal panel 31.

As described above, the present self-piercing nut is adapted to fixation to relatively thick metal panels such as those which are usually incorporated into buildings or the like architectures.

1. A self-piercing nut for use with thick panels comprising:
a generally square nut body with four side walls,
a pilot portion formed on and integral with the nut body and around a central threaded bore thereof,
the pilot portion having a projected end face to punch a hole in a metal panel as any of the thick panels and having an outer periphery tapered to inwardly reduce diameter across a nut axis,
a panel engaging groove formed around and outside the pilot portion and opened sideways at regions except for four corners of the nut boy,
four independent corner posts formed integral with the respective corners so as to provide four seat faces, and
the pilot portion having an end face projected beyond the seat faces in a direction of the nut axis,
wherein the nut body is a pressed article of boron steel and is entirely hardened by the quenching process, a height ‘H’ defined between a bottom of the panel engaging groove and the pilot portion end face is substantially equal to an allowable maximum thickness of the metal panel, and another height ‘h’ defined between the seat face of each corner post and the pilot portion end face is substantially equal to an allowable minimum thickness of the metal panel.

2. A self-piercing nut as defined in claim 1, wherein the boron steel contains about 0.17% or less by weight of carbon so that it shows a Rockwell hardness HRC-30 or higher after hardened by the quenching process.

3. A self-piercing nut as defined in claim 1 or 2, wherein the maximum thickness is about 3.2 mm, with the minimum thickness being about 1.6 mm.

4. A self-piercing nut as defined in claim 1 or 2, wherein when the pilot portion punches a round hole in the metal panel so that a circular edge of this hole is forcibly caulked into the panel engaging groove, the seat faces of the corner posts are caused to bite the panel at its areas near the circular edge if the thickness of the panel is greater than a threshold.

5. A self-piercing nut as defined in claim 4, wherein the corner posts are capable of buckling vertically and swelling sideways when the seat faces bite the metal panel.

6. A self-piercing nut as defined in claim 5, wherein the pilot portion has an outer periphery with an uneven contour in cross section.

7. A self-piercing nut as defined in claim 3, wherein when the pilot portion punches a round hole in the metal panel so that a circular edge of this hole is forcibly caulked into the panel engaging groove, the seat faces of the corner posts are caused to bite the panel at its areas near the circular edge if the thickness of the panel is greater than a threshold.

8. A self-piercing nut as defined in claim 7, wherein the corner posts are capable of buckling vertically and swelling sideways when the seat faces bite the metal panel.

9. A self-piercing nut as defined in claim 8, wherein the pilot portion has an outer periphery with an uneven contour in cross section.
